(19) United States
(12) Patent Application Publication
(10) Pub. No.: US 2019/0009426 A1
(43) Pub. Date: Jan. 10, 2019

(54) Knife, knife holder and knife assembly and method of using the same

(71) Applicant: BID GROUP TECHNOLOGIES LTD., Prince George (CA)

(72) Inventors: Stephane Horth, Boisbriand (CA); Jacques Maugery, Saint-Georges (CA); Pierre Faucher, Saint-Georges (CA); Michel Rheaume, St-Raymond (CA)

(21) Appl. No.: 16/028,336

(22) Filed: Jul. 5, 2018

Related U.S. Application Data
(60) Provisional application No. 62/528,592, filed on Jul. 5, 2017.

(51) Int. Cl. B27L 11/00; B27G 13/10; B27G 13/04

(52) U.S. Cl. CPC B27L 11/005; B24B 3/36; B27G 13/04; B27G 13/10

(57) ABSTRACT

The present invention relates to a knife, knife holder and knife assembly for cutting and shaping wood logs. The knife assembly provides an improved knife stability and a flexible adjustment of the different components of the knife assembly. The present invention allows both the underside clamping and the topside clamping of the knife assembly to a support tool and provides a method for both clamping processes.

### CROSS-REFERENCE TO RELATED APPLICATIONS

The present patent application claims the benefits of priority of U.S. Provisional Patent Application No. 62/528,592, entitled “Knife, Knife Holder and Knife Assembly and Method of Using the Same”, and filed at the United States Patent and Trademark Office on Jul. 5, 2017, the content of which is incorporated herein by reference.

### FIELD OF THE INVENTION

The present invention generally relates to wood cutting apparatuses and methods of using the same. Particularly, the present invention relates to wood cutting knifes, knife holders and knife assemblies and method of using the same.

### BACKGROUND OF THE INVENTION

Conventionally, various wood cutting apparatus employ removable knives in order to facilitate maintenance, repair and replacement of knives. However, these cutting apparatus do not allow producing a high quality dimensioned lumber because the knives are usually held in an unstable configuration and are exposed to highly episodic cutting forces over prolonged periods of time.

More recently, other cutting assemblies, such as the chipper disc assembly disclosed in the U.S. Pat. No. 5,271,440, provided a double-sided knife being reversible and sharpenable and having a flat bottom surface adapted to engage a flat engaging surface of a counter knife and a serrated top surface adapted to be firmly mating a complementary clamping surface of a clamping member. The double-sided knife is thus being held between the clamp and the counter knife by the means of the top surface’ serrations which provides more stability to the knife during operation. However, such assemblies are not only more difficult to be manufactured and costlier but still remain partially unstable due to the presence of the flat bottom surface.

Furthermore, other knife assemblies, such as the one disclosed in the Canadian patent application No. 2,453,688 provide a solution for further improving the stability of the knife in a knife assembly for use in wood cutting apparatus. Such a solution aims at providing a “three-point” contact made between the assembly and the knife comprising two points on the bottom surface of the knife and one point on the top surface of the knife. However, such a contact does not allow to equally distribute the loads over the surfaces of the knife which creates stress concentrations around the three points of contact and facilitates the structural damage of the knife around theses points.

Stager, U.S. Pat. No. 7,677,282, assigned to Key Knife, Inc., describes a double-sided knife providing a double-indexing of the knife to the knife assembly, thus, both the upper and the lower clamping members are adapted to be removably mounted to the knife. However, in such a configuration, the clamping members are shaped in a way to allow only a flexible adjustment of the knife relatively to the clamping members and not a flexible adjustment of clamping members one relative to the other, which provides more limited adjustment flexibility of the knife in the knife assembly.

### SUMMARY OF THE INVENTION

The shortcomings of the prior art are generally mitigated by providing a knife assembly and method of using the same.

The knife assembly and method according to the present invention aims at improving the stability of a cutting knife of a knife assembly by providing a double side positioning of the knife relatively to the clamping members and a flexible adjustment of the clamping members one relatively to the other.

In another aspect of the invention, the knife assembly aims at facilitating maintenance, repair and replacement of knives by providing an easily removable and reversible double-sided knife.

In yet another aspect of the invention, the knife assembly aims at improving the removed lumber quality by providing a stable knife configuration even once exposed to highly episodic cutting forces over prolonged periods of time.

In a further aspect of the invention, a knife assembly is disclosed. The knife assembly comprises a first clamping member adapted to retain and position a knife, the first clamping member being further adapted be mounted to a surface and a second clamping member adapted to be positioned with regard to the knife when pressed against the first clamping member, the second clamping member being mountable to the first clamping member to maintain the pression on the knife.

The knife may have a width and the first and second clamping members may be shaped to force the second clamping member against the knife along an axis substantially parallel to the width of the knife when the first and second clamping members are pressed one against the other.

The first clamping member may comprise a projection and the second clamping member may comprise a pressure surface at an end of the second clamping member adapted for the second clamping member to be forced against the knife along an axis substantially parallel to the width of the knife when the first and second clamping members are pressed one against the other.

The projection of the first clamping member may be a slanted surface and the pression surface of the second clamping member may be a slanted surface having an angle substantially opposite to the projection of the first clamping member.

The first clamping member may further comprise a retaining portion adapted to retain the knife toward an end of the first clamping member along an axis substantially parallel to the width of the knife. The retaining portion may be a protrusion shaped to mate with the knife or be shaped as an ‘s’ or a ‘z’.

The second clamping member may comprise a pushing portion adapted to press against one side of the knife along an axis substantially parallel to the width of the knife or the second clamping member may comprise a pulling portion adapted to pull one side of the knife along an axis substantially parallel to the width of the knife. One of the first and second clamping members may comprise a pulling portion adapted to pull one side of the knife along an axis substantially parallel to the width of the knife and the other of the first and second clamping members may comprise a pushing portion adapted to press against one side of the knife along an axis substantially parallel to the width of the knife.

The knife may comprise a first side adapted to be pulled and a second side adapted to be pushed, one of the first and second clamping members may be adapted to pull the first side of the knife and the second of the first and second clamping members may be adapted to push the second side of the knife, the resulting pulling and pushing effects holding the knife to the assembly. The first and second sides of the knife may be substantially parallel and may have a substantially flat top and bottom surfaces each defining top and bottom reference surfaces, the top reference surface being downwardly offset of the top surface to define a first recess, the bottom reference surface may further be upwardly offset of the bottom surface to define a second recess being located on the opposite side of the first recess.

The first clamping member and second clamping member may each define substantially parallel and substantially flat surfaces adapted to face each another, the substantially flat surface of the one of the first and second clamping member may define a recess, the recess of the one of the first and second clamping members may be located to contact one of the first and second recesses of the knife.

A portion of the substantially flat surface of the second clamping member may be shaped to contact one of the first and second recesses of the knife or to contact one of a first and second projections of the knife.

In yet another aspect of the invention, a method to hold a knife to a surface is disclosed. The method comprises positioning a first side of the knife on a first clamping member to be held to the first clamping member, placing a second clamping member on a second side of the knife, orienting the second clamping member with regard to the second side of the knife and pressing one of the first and second clamping members one against the other to force the second clamping member against the knife along an axis substantially parallel to a width of the knife.

The step of pressing the one of the first and second clamping members may further comprise pushing the other of the first and second clamping member against one side of the knife, pulling the other of the first and second clamping member against one side of the knife or the one of the first and second clamping member pulling a first side of the knife and the other of the first and second clamping members pushing a second side of the knife.

The step of positioning a first side of the knife on one of the first and second clamping members may further comprise positioning a first recess of the first side of the knife to mate the other of the first and second clamping members contacting the first side of the knife or positioning a first projection of the first side of the knife to mate with the other of the first and second clamping members contacting the first side of the knife.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of a knife assembly being adapted for an underside clamping in accordance with the principles of present invention.

FIG. 2 is a sectional side view of the knife assembly of FIG. 1 illustrating an underside clamping of the knife assembly in accordance with the principles of the present invention.

FIG. 3 is a close-up view of the knife assembly of FIG. 2 illustrating the positioning of the knife relatively to top and bottom clamping members.

FIG. 4 is a perspective view of a second embodiment of a knife assembly being adapted for a topside clamping in accordance with the principles of the present invention.

FIG. 5 is a sectional side view of the knife assembly of FIG. 4 illustrating a topside clamping of the knife assembly in accordance with the principles of the present invention.

FIG. 6 is a side plan view of a third embodiment of a knife assembly being adapted for a topside clamping in accordance with the principles of the present invention.

FIG. 7 is a sectional side view of the knife assembly of FIG. 6 illustrating a topside clamping of the knife assembly in accordance with the principles of the present invention.

FIG. 8 is a close-up sectional view of the knife assembly of FIG. 6 illustrating the resulting forces of a topside clamping of the knife assembly in accordance with the principles of the present invention.

### DETAILED DESCRIPTION OF THE PREFERRED EMBODIMENT

A novel knife, knife holder and knife assembly and method of using the same will be described hereinafter. Although the invention is described in terms of specific illustrative embodiments, it is to be understood that the embodiments described herein are by way of example only and that the scope of the invention is not intended to be limited thereby.

Throughout the description of the several embodiments of the present invention, reference will be made, particularly, to knife assemblies comprising a knife and a knife holder. Thus, it is to be understood that knife assemblies according to the present invention, may be adapted to be used in chipping discs, waferizers, drum chippers, ring slicers, conical chippers or canters, and any similar cutting apparatus used in the wood processing industry.

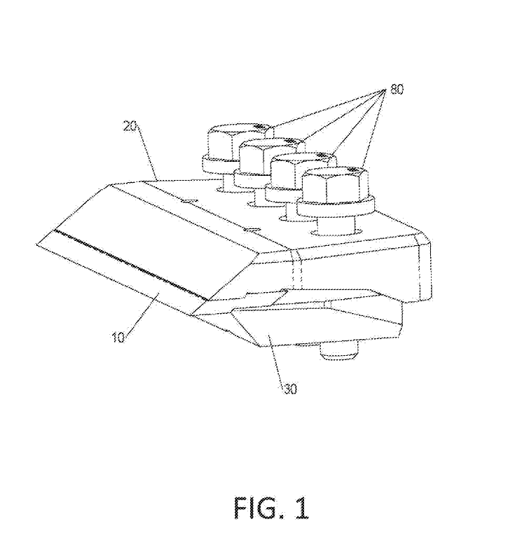

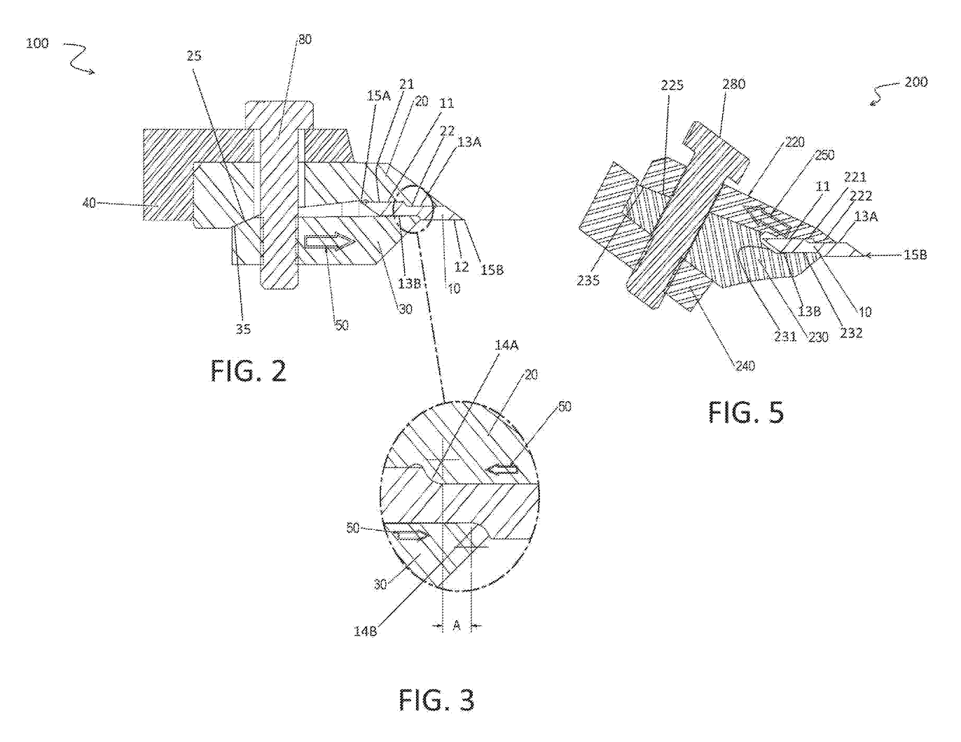

Referring to FIGS. 1 and 2, a first embodiment of a knife assembly 100 showing an underside clamping of the knife assembly 100 to a tool support 40 is illustrated. The knife assembly 100 comprises a first clamping member 20 and a second clamping member 30 both adapted to receive a knife 10. The second clamping member 30 comprises at one extremity an inclined surface 35 being configured to precisely and slidably mate with an inclined surface 25 of the first clamping member 20. The presence of such inclined surfaces 25 and 35 allows a flexible and precise adjustment of the knife assembly 100.

In some embodiments, the inclined surfaces 25 and 35 should be adapted to take in consideration the thickness of the knife 10 when received between the first clamping member 20 and the second clamping member 30.

Referring now to FIGS. 1 to 3, the knife 10 generally comprises two substantially parallel and substantially flat top and bottom surfaces 11 and 12 defining each a reference surface 13A and 13B. The top reference surface 13A is downwardly offset of the top surface 11 to define a recess 14A. The bottom reference surface 13B is upwardly offset of the bottom surface 12 to define a recess 14B being located on the opposite side of the recess 14A. Understandably, in such a configuration, the knife 10 is generally shaped as an ‘s’ or a ‘z’.

In some embodiments, the knife 10 comprises two substantially parallel cutting edges 15A and 15B. In such embodiments, the knife may be double-sided and reversible.

In some embodiments of underside clamping of the knife assembly 100, the first clamping member 20 is adapted to be upwardly attached to the bottom side of the tool support 40. In such embodiments, the first clamping member 20 comprises a recess 21 and a projection 22 to properly position the knife 10 and to properly orientate the cutting edge 15B. The recess 21 is typically configured to receive the top surface 11 of the knife 10 and the projection 22 is configured to fit the top reference surface 13A of the knife 10. Thus, the knife 10 is adapted to be positioned relatively to the first clamping member 20.

The second clamping member 30 is pressed against and/or attached to the first clamping member 20. The pression between the first 20 and the second clamping member 30 aims at maintaining the knife 10 in place. The first 20 and second clamping member 30 may further be attached to the tool support 40 using the same attachment mean, such as a bolt or fastener 80. The second clamping member 30 is positioned with regard to the knife 10 and is adapted to fit the bottom reference surface 13B.

Understandably, the shape and the configuration of the knife 10, the first clamping member 20 and the second clamping member 30 allow a double-side positioning of the knife 10 relatively to the first and second clamping member 20 and 30 aiming at improving the stability of the knife 10 and thus of the resulting lumber quality.

Still referring to FIGS. 1 to 3, a method of an underside clamping of the knife assembly 100 to a surface is illustrated. Preferably, the knife assembly is mounted to the bottom side of the tool support 40. The method comprises upwardly attaching the first clamping member 20 to the bottom side of the tool support 40 and positioning the top side of the knife 10 relatively to the first clamping member 20. The method further comprises the second clamping member 30 being oriented with regard to the knife 10, preferably relatively to the bottom side of the knife 10. The method further comprises pressing the first clamping member 20 against the second clamping member 30. Such pression creates a longitudinal force 50 in the direction of the cutting edge 15B on the second clamping member 20 and in a way to abut the second clamping member 30 in the recess 14B of the bottom surface 12 of the knife 10 and in a way to abut the projection 22 of the first clamping member 20 in the recess 14A of the top surface 11 of the knife 10. The method may further comprise slidably positioning the inclined surface 35 of the second clamping member 30 over the inclined surface 25 of the first clamping member 20 while exerting the longitudinal force 50. The method may further comprise assembling the knife assembly 100 to the bottom side of the tool support 40 by the mean of a fastener 80.

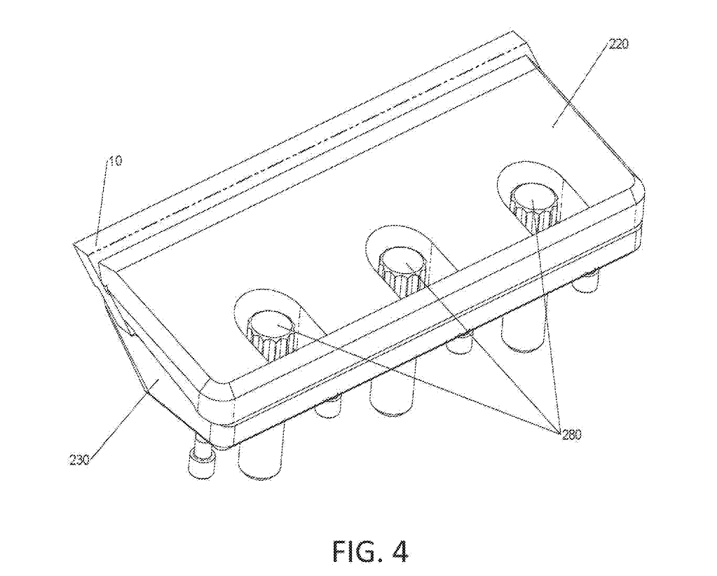

Referring now to FIGS. 4 and 5, a second embodiment of a knife assembly 200 showing a topside clamping of the knife assembly 200 to a tool support 240 is illustrated. In such an embodiment, the knife assembly 200 comprises a first clamping member 230 and a second clamping member 220. The first clamping member 230 being shaped and/or adapted to receive and position a knife 10. The second clamping member 220 being shaped and adapted to be oriented with regard to the knife 10 when pressed against the first clamping member 230. Preferably, the first clamping member 230 comprises an inclined surface 235 adapted to slidably mate with an inclined or slanted surface 225 of the second clamping member 220. Such inclined surfaces 225 and 235 generally aims at flexibly and precisely adjust the knife assembly 200.

In embodiment having topside clamping of the knife 10, the bottom portion of the first clamping member 230 is adapted to be attached to the tool support 240. Preferably, the first clamping member 230 comprises a recess 231 and a projection 232 to properly position the knife 10 and to properly orientate the cut edge 15B of the knife 10. The recess 231 is typically adapted to receive a side surface of the knife 10 and the projection 232 is configured to generally fit the bottom reference surface 13B of the knife 10. Thus, the knife 10 is adapted to be positioned relatively by the first clamping member 230.

In order to retain the knife 10 in place, the second clamping member 220 is attached to the first clamping member 230. In some embodiments, the first clamping member 230 and the second clamping member 220 are mounted to the tool support 240 using a means of a fastener 280, such as a bolt or a fastener. The second clamping member 220 is positioned or oriented in relation to the knife 10. In some embodiments, the second clamping member 220 may comprise a recess 221 and a projection 222. The projection 222 is generally adapted to engage the top reference surface 13A of the knife 10 and the recess 221 is generally adapted to receive the top surface 11 of the knife 10. Thus, the first clamping member 220 is adapted to be positioned in relation to the knife 10.

Understandably, the shape and the configuration of the knife 10, of the first clamping member 230 and of the second clamping member 220 allow positioning the two sides of the knife 10 in relation to the first and second clamping member 230 and 220, generally aiming at improving the stability of the knife 10 and thus the removed lumber quality.

Still referring to FIGS. 3 to 5, a method of a topside clamping of the knife assembly 200 to a surface is illustrated. Preferably, the knife assembly 200 is mounted to the top side of the tool support 240. The method comprises mounting or attaching a bottom portion of the first clamping member 230 to the surface and positioning the one side of the knife 10 on the first clamping member 230. In some embodiments, the bottom portion of the first clamping member 230 is mounted to the top side of the tool support 240. The method further comprises positioning and/or orienting the second clamping member 220 in relation to the other side of the knife 10. The method further comprises pressing or attaching the first clamping member 230 to the second clamping member 220 to create a substantially longitudinal force 250 to pull or retain the knife 10. In some embodiments, of the force is applied on the recess 14B of the bottom surface o12 of the knife 10. The method may further comprise abutting the projection 222 of the second clamping member 220 to the recess 14B. The method may further comprise slidably positioning the inclined surface 225 of the second clamping member 220 about the inclined surface 235 of the first clamping member 230 while exerting the longitudinal force 250. The method may further comprise assembling the knife assembly 200 to the top side of the tool support 240 by the mean of a fastener.

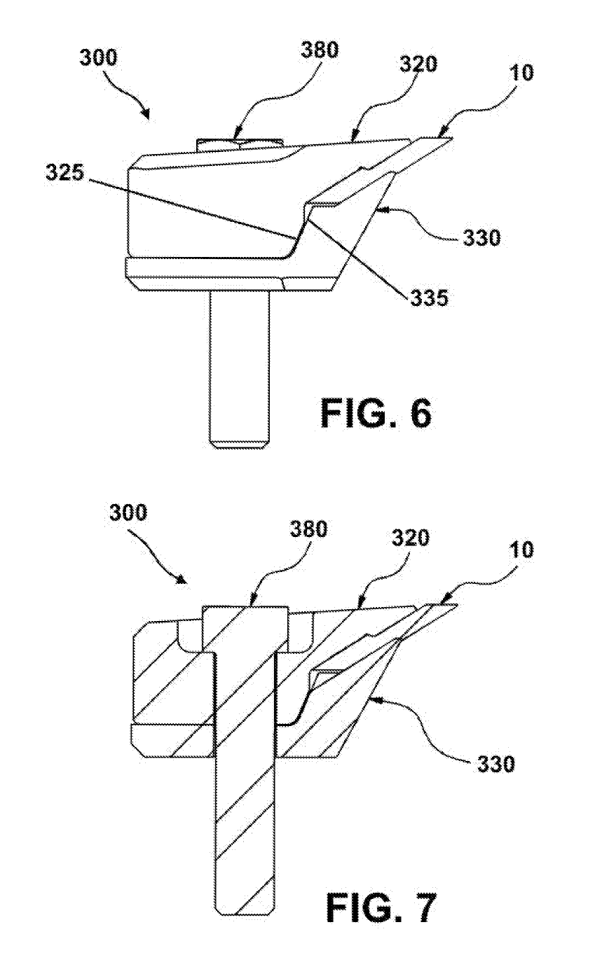

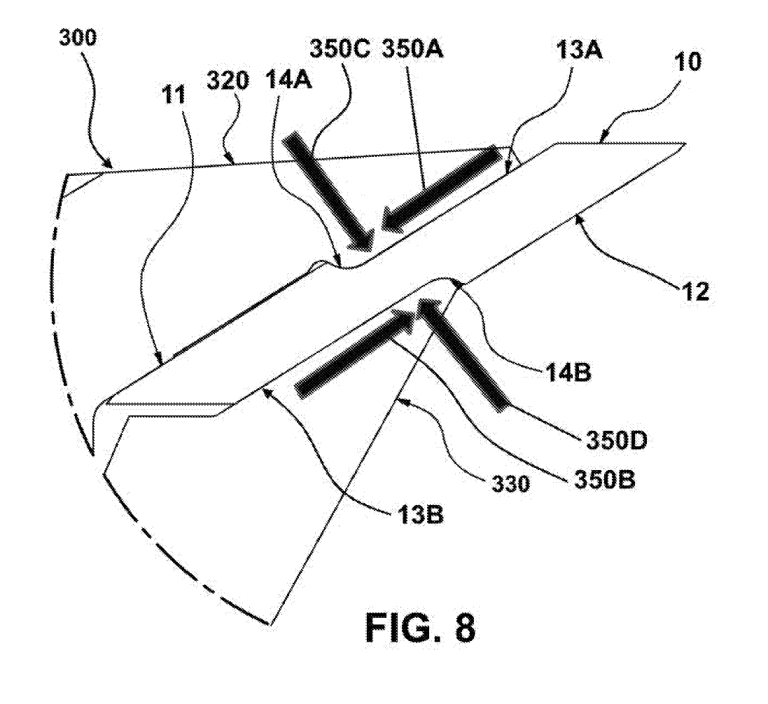

Now referring to FIGS. 5 to 7, a third embodiment of a knife assembly 300 showing a topside clamping of the knife assembly 300 to a surface is illustrated. In such an embodiment, the knife assembly 300 comprises a first clamping member 330 and a second clamping member 320. The first clamping member 330 is generally shaped and/or adapted to receive and position the knife 10. The second clamping member 320 is generally shaped and adapted to be oriented with regard to the knife 10 when pressed against the first clamping member 330. Preferably, the first clamping member 330 comprises an inclined surface 335 adapted to slidably mate with an inclined or slanted surface 325 of the second clamping member 320. Such inclined surfaces 325 and 335 generally aims at flexibly and precisely adjust the knife assembly 300.

Now referring to FIG. 7, the resulting forces 350A to 350D of the clamping members 330 and 320 are shown. As the second clamping member 320 is pressed against the first clamping member 330, the second clamping member 320 is forced inwardly or in a force 350A generally directed along the width of the knife 10. Such force 350A may be created by the inclined surfaces 325 and 335 being pressed one against the other. Another force 350B resulting from the first clamping member 330 pushing or retaining on the knife 10 (typically on the recess 14B) is created to counterbalance the force 350A. Obviously, the forces 350C and 350D are created as a result of the pression between the first 230 and second 220 clamping members when mounted or attached to one another. In some embodiments, the forces 350C and 350D are components of the force being perpendicular to the width of the knife 10.

Understandably, the knife assembly 100 may be adapted to a topside clamping process by simply inverting upside-down the knife assembly 100 once being attached to the tool support 240.

Understandably, the knife assembly 200 may be adapted to an underside clamping process by simply inverting upside-down the knife assembly 200 once being attached to the tool support 40.

Understandably, in another embodiment, the knife 10 may have a different shape adapted to fit to other adapted clamping members.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A knife assembly comprising:
a) a first clamping member adapted to retain and position a knife, the first clamping member being further adapted be mounted to a surface;
b) a second clamping member adapted to be positioned with regard to the knife when pressed against the first clamping member, the second clamping member being mountable to the first clamping member to maintain the pression on the knife.

2) The knife assembly of claim 1, the knife having a width, the first and second clamping members being shaped to force the second clamping member against the knife along an axis substantially parallel to the width of the knife when the first and second clamping members are pressed one against the other.

3) The knife assembly of claim 2, the first clamping member comprising a projection and the second clamping member comprising a pressure surface at an end of the second clamping member adapted for the second clamping member to be forced against the knife along an axis substantially parallel to the width of the knife when the first and second clamping members are pressed one against the other.

4) The knife assembly of claim 3, the projection of the first clamping member being a slanted surface and the pression surface of the second clamping member being a slanted surface having an angle substantially opposite to the projection of the first clamping member.

5) The knife assembly of claim 3, the first clamping member comprising a retaining portion adapted to retain the knife toward an end of the first clamping member along an axis substantially parallel to the width of the knife.

6) The knife assembly of claim 5, the retaining portion being a protrusion shaped to mate with the knife.

7) The knife assembly of claim 5, the retaining portion being shaped as an ‘s’ or a ‘z’.

8) The knife assembly of claim 1, the second clamping member comprising a pushing portion adapted to press against one side of the knife along an axis substantially parallel to the width of the knife.

9) The knife assembly of claim 1, the second clamping member comprising a pulling portion adapted to pull one side of the knife along an axis substantially parallel to the width of the knife.

10) The knife assembly of claim 1, one of the first and second clamping members comprising a pulling portion adapted to pull one side of the knife along an axis substantially parallel to the width of the knife and the other of the first and second clamping members comprising a pushing portion adapted to press against one side of the knife along an axis substantially parallel to the width of the knife.

11) The knife assembly of claim 10, the knife comprising a first side adapted to be pulled and a second side adapted to be pushed, one of the first and second clamping members being adapted to pull the first side of the knife and the second of the first and second clamping members being adapted to push the second side of the knife, the resulting pulling and pushing effects holding the knife to the assembly.

12) The knife assembly of claim 11, the first and second sides of the knife being substantially parallel and having substantially flat top and bottom surfaces each defining top and bottom reference surfaces, the top reference surface being downwardly offset of the top surface to define a first recess, the bottom reference surface being upwardly offset of the bottom surface to define a second recess being located on the opposite side of the first recess.

13) The knife assembly of claim 12, the first clamping member and second clamping member each defining substantially parallel and substantially flat surfaces adapted to face each another, the substantially flat surface of the one of the first and second clamping member defining a recess, the recess of the one of the first and second clamping members being located to contact one of the first and second recesses of the knife.

14) The knife assembly of claim 12, a portion of the substantially flat surface of the second clamping member being shaped to contact one of the first and second recesses of the knife.

15) The knife assembly of claim 12, a portion of the substantially flat surface of the second clamping member being shaped to contact one of a first and second projections of the knife.

16) A method to hold a knife to a surface, the method comprising:
a) positioning a first side of the knife on a first clamping member to be held to the first clamping member;
b) placing a second clamping member on a second side of the knife;
c) orienting the second clamping member with regard to the second side of the knife;
d) pressing one of the first and second clamping members one against the other to force the second clamping member against the knife along an axis substantially parallel to a width of the knife.

17) The method to hold a knife to a surface of claim 16, pressing the one of the first and second clamping members pushing the other of the first and second clamping member against one side of the knife.

18) The method to hold a knife to a surface of claim 16, pressing the one of the first and second clamping members pulling the other of the first and second clamping member against one side of the knife.

19) The method to hold a knife to a surface of claim 16, pressing the one of the first and second clamping members further comprising the one of the first and second clamping member pulling a first side of the knife and the other of the first and second clamping members pushing a second side of the knife.

20) The method to hold a knife to a surface of claim 16, positioning a first side of the knife on one of the first and second clamping members further comprising positioning a first recess of the first side of the knife to mate the other of the first and second clamping members contacting the first side of the knife.

21) The method to hold a knife to a surface of claim 16, positioning a first side of the knife on one of the first and second clamping members further comprising positioning a first projection of the first side of the knife to mate with the other of the first and second clamping members contacting the first side of the knife.
